(19) United States
(12) Patent Application Publication
(10) Pub. No.: US 2008/0271074 A1
(43) Pub. Date: Oct. 30, 2008

(54) METHOD FOR PROVIDING SERVICE INFORMATION AND APPARATUS THEREOF

(75) Inventors: Dae-gyu BAE, Suwon-si (KR); Ho-jeong You, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/955,904

(22) Filed: Dec. 13, 2007

Related U.S. Application Data
(60) Provisional application No. 60/913,615, filed on Apr. 24, 2007.

(30) Foreign Application Priority Data
Jun. 18, 2007 (KR) 10-2007-0059611

(51) Int. Cl. H04N 5/445

(52) U.S. Cl. 725/38

(57) ABSTRACT

A method for providing service information and a video apparatus employing the same are provided. The method for providing service information includes transmitting a request message for service information provided by an external apparatus connected according to the High Definition Multimedia Interface Consumer Electronics Control (HDMI CEC) standard, and receiving a reply message for the service information from the external apparatus as a reply to the request message. Accordingly, the video apparatus provides service information provided by the external apparatus connected thereto to a user.

### CROSS-REFERENCE TO RELATED APPLICATIONS

This application claims priority from U.S. Provisional Patent Application No. 60/913,615 filed on Apr. 24, 2007, in the United States Patent and Trademark Office, and from Korean Patent Application No. 10-2007-0059611 filed on Jun. 18, 2007, in the Korean Intellectual Property Office, the entire disclosures of which are hereby incorporated by reference.

### BACKGROUND OF THE INVENTION

1. Field of the Invention

Methods and apparatuses consistent with the present invention relate to providing service information, and more particularly, to a method for providing service information of an external apparatus connected to a video apparatus, and a video apparatus employing the same, and also to a method for providing service information of a video apparatus to an external apparatus connected to the video apparatus, and a video apparatus employing the same.

2. Description of the Related Art

FIG. 1 is a diagram illustrating a video system which comprises apparatuses connected to each other according to the High Definition Multimedia Interface Consumer Electronics Control (HDMI CEC) standard. The video system shown in FIG. 1 is established by connecting a television (TV) 10 and a digital versatile disc recorder (DVDR) 20 according to the HDMI CEC standard. In addition to video signals, control signal are transceived between the TV 10 and the DVDR 20.

Accordingly, the TV 10 controls operation of the DVDR 20 according to a user's command transmitted through a remote controller 15, so that a user enjoys services such as music provided from the DVDR 20. However, a user is required to detect external apparatuses connected to the TV in order to enjoy a music service. The user selects one of the external apparatus connected to the TV that provides a music service, and selects a music service from various service functions of the selected external apparatus.

As described above, in order to receive a particular service, a user should be aware of what kind of apparatus can provide the particular service, which may cause an inconvenience to a user. Also, if a user is not aware of what apparatus provides a service the user wishes to receive, the user should ascertain respective functions of all external apparatuses connected to the TV 10 to find the apparatus providing the particular service, which may also cause an inconvenience to a user.

Recently, there are many kinds of external apparatuses and these external apparatuses diversify their respective services, and users are interested in a particular service itself, rather than the external apparatus providing the particular service. In consideration of these recent situations, a video system does not satisfy users' demands if it cannot directly provide service information to users.

### SUMMARY OF THE INVENTION

The present invention provides a method for obtaining service information provided from a connected external apparatus, and a video apparatus employing the same.

Also, the present invention provides a method for generating service information provided by a video apparatus and providing the generated service information to an external apparatus connected to the video apparatus, and a video apparatus employing the same.

According to an aspect of the present invention, there is provided a method for providing service information, comprising: transmitting a request message for service information provided by an external apparatus connected according to the HDMI CEC standard; and receiving a reply message for the service information from the external apparatus as a reply to the request message.

The request message may comprise data for requesting the service information.

The reply message may comprise at least one of data for replying to the request message, a service identifier (ID) provided by the external apparatus, and a service name provided by the external apparatus.

The method may further comprise transmitting a service execution request message to request an execution of a particular service contained in the reply message.

The service execution request message may comprise at least one of data for requesting the service execution and a service ID of the particular service.

The method may further comprise generating a list of services based on the reply message; and displaying the generated list of services.

The list of services may comprise at least one of a service name provided by the external apparatus and an icon of the external apparatus.

According to another aspect of the present invention, there is provided a method for providing service information of a video apparatus, comprising: receiving a request message for service information from an external apparatus connected to the video apparatus according to the HDMI CEC standard; and in response to the request message, transmitting a reply message for service information provided by the video apparatus to the external apparatus.

The request message may comprise data for requesting the service information.

The reply message may comprise at least one of data for replying to the request message, a service ID provided by the video apparatus, and a service name provided by the video apparatus.

The method may further comprise receiving a service execution request message from the external apparatus for requesting an execution of a particular service contained in the reply message.

The service execution request message may comprise at least one of data for requesting the service execution and a service ID of the particular service.

According to still another aspect of the present invention, there is provided a video apparatus comprising: a controller which generates a request message for service information provided by an external apparatus connected to the video apparatus according to the HDMI CEC standard; and an interface which transmits the request message to the external apparatus.

The request message may comprise data for requesting the service information.

The interface may receive a reply message for replying to the request message from the external apparatus.

The reply message may comprise at least one of data for replying to the request message, a service ID provided by the external apparatus, and a service name provided by the external apparatus.

The controller may generate a service execution request message to request an execution of a particular service contained in the reply message, and the interface may transmit the service execution request message to the external apparatus.

The service execution request message may comprise at least one of data for requesting the service execution and a service ID of the particular service.

According to still another aspect of the present invention, there is provided a video apparatus for providing service information, comprising: an interface which receives a request message for service information from an external apparatus connected to the video apparatus according to the HDMI CEC standard; and a controller which, in response to the request message, generates a reply message for the service information provided by the video apparatus, and transmits the reply message to the external apparatus through the interface.

The reply message may comprise at least one of data for replying to the request message, a service ID provided by the video apparatus, and a service name provided by the video apparatus.

### BRIEF DESCRIPTION OF THE DRAWINGS

The above and other aspects of the present invention will become apparent and more readily appreciated from the following description of exemplary embodiments, taken in conjunction with the accompany drawings of which:

FIG. 1 is a diagram illustrating a video system according to the HDMI CEC standard;

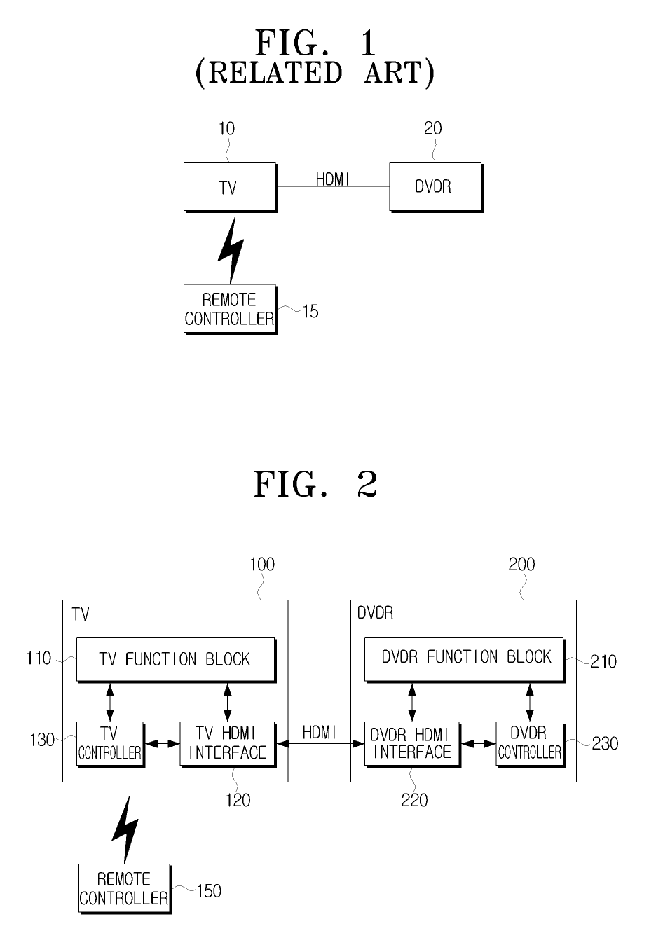

FIG. 2 is a block diagram illustrating a video system to which an exemplary embodiment of the present invention is applicable;

FIG. 3 is a view illustrating a method for providing service information according to an exemplary embodiment of the present invention;

FIGS. 4A to 4E are views illustrating a message structure in relation to service information according to an exemplary embodiment of the present invention;

FIGS. 5A to 5C are views illustrating a list of services according to an exemplary embodiment of the present invention; and

FIGS. 6 to 9 are views illustrating a method for providing service information and an apparatus employing the same according to other exemplary embodiments of the present invention.

### DETAILED DESCRIPTION OF EXEMPLARY EMBODIMENTS OF THE PRESENT INVENTION

Certain exemplary embodiments of the present invention will be described in greater detail with reference to the accompanying drawings.

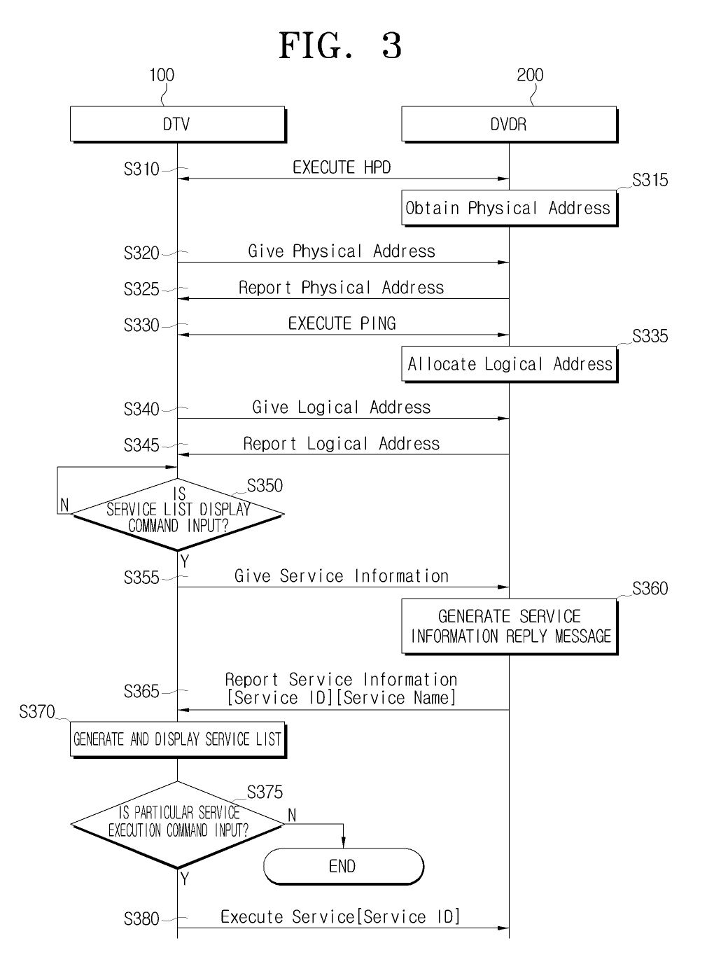

FIG. 2 is a block diagram illustrating a video system to which an exemplary embodiment of the present invention is applicable. The video system shown in FIG. 2 is established by connecting a TV 100 and a DVDR 200 according to the HDMI CEC standard.

As shown in FIG. 2, the TV 100 comprises a TV function block 110, a TV HDMI interface 120, and a TV controller 130, and receives a command from a user through a remote controller 150.

The TV function block 110 performs its own proper functions. More specifically, the TV function block 110 processes broadcast signals received from a broadcasting station in a wire or wireless manner, for example, decodes and scales the signals, and then displays the signals on a display, thereby providing a broadcast to a user. Also, the TV function block 110 may display an image corresponding to video signals transmitted from the DVDR 200 through the TV HDMI interface 120, which will be described in detail below.

Also, the TV function block 110 displays a list of services on a display and thereby provides a user with a user interface (UI). The list of services displayed on the display by the TV function block 110 includes a list of services provided by the TV 100 and a list of services provided by external apparatuses connected to the TV 100.

The TV HDMI interface 120 is connected to the DVDR 200 according to the HDMI CEC standard to allow video signals and messages to be transceived between the TV and the DVDR 200.

The TV controller 130 controls operation of the TV function block 110 according to a user's command transmitted through the remote controller 150. Also, the TV controller 130 transmits a control command to the DVDR 200 through the TV HDMI interface 120 and thereby controls operation of the DVDR 200.

Upon receiving a command to display a list of services from a user, the TV controller 130 generates a request message for service information and transmits the generated request message to the external apparatuses connected to the TV 100. Upon receiving a reply message from the external apparatuses connected to the TV 100, the TV controller 130 generates a list of services based on the received reply message. The services provided by the external apparatuses may overlap. For example, an MP3 player and the DVDR 200 both provide ‘music’ service. As such, if there is a plurality of external apparatuses providing the same service, the TV controller 130 generates a list of services containing icons or names representing external apparatuses so that a user can distinguish services and select a service provided by any one of the plurality of external apparatuses.

Also, if a user's command to execute a particular service is received, the TV controller 130 generates a service execution request message to an external apparatus providing the particular service, and controls the TV HDMI interface 120 to transmit the generated service execution request message to the external apparatus providing the particular service therethrough.

As shown in FIG. 2, the DVDR 200 comprises a DVDR function block 210, a DVDR HDMI interface 220, and a DVDR controller 230.

The DVDR function block 210 records broadcast signals input from the TV 100 through the DVDR HDMI interface 220, which will be described in detail below, on a DVD mounted thereon, or reads video signals from the mounted DVD and provides the video signals to the TV 100 through the DVDR HDMI interface 220.

The DVDR HDMI interface 220 is connected with the TV 100 according to the HDMI CEC standard to allow video signals and messages to be transceived between the TV 100 and DVDR 200.

The DVDR controller 230 controls operation of the DVDR function block 210 according to a control command transmitted from the TV controller 130 through the DVDR HDMI interface 220.

Also, the DVDR controller 230 generates a message containing a service ID and a service name for service information provided by the DVDR 200 to transmit the service information to the TV 100, and transmits the generated message to the TV 100 through the DVDR HDMI interface 220.

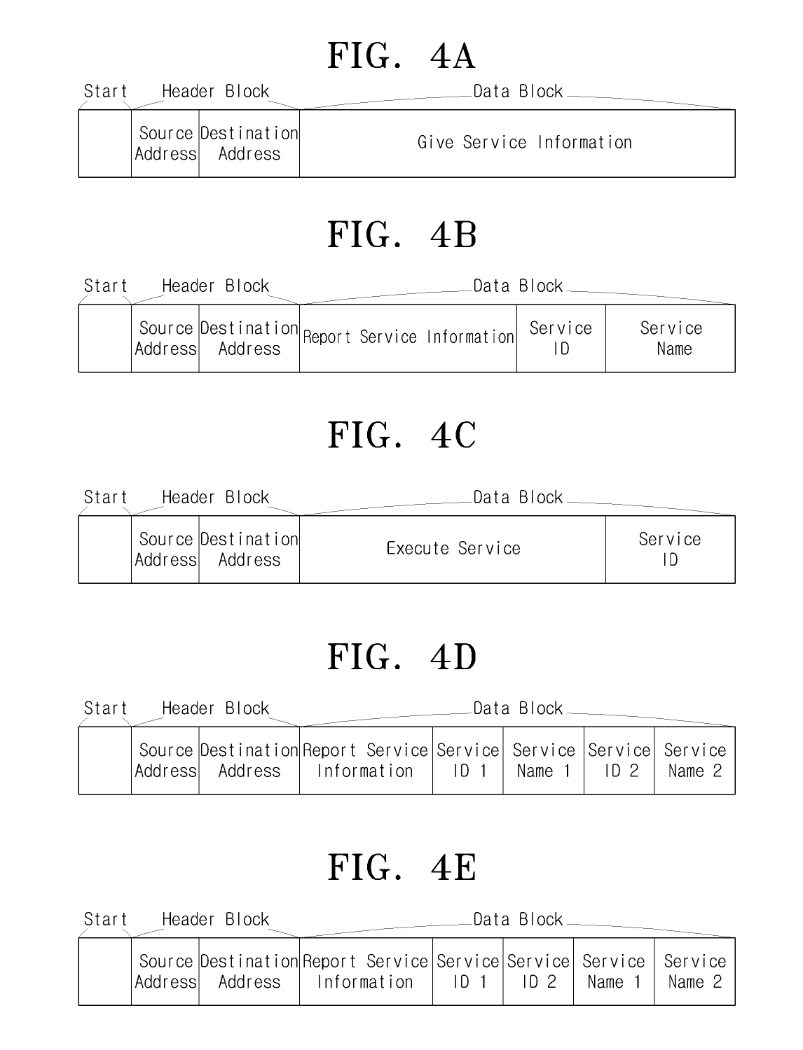

Hereinafter, a series of processes of the TV 100 obtaining service information from an external apparatus, and generating and displaying a list of services from the obtained service information will be described with reference to FIG. 3. FIG. 3 is a view illustrating a method for providing service information according to an exemplary embodiment of the present invention.

As shown in FIG. 3, if the TV 100 is connected to the DVDR 200 according to the HDMI CEC standard, an HDMI hot plug detection (HPD) is executed between the TV 100 and the DVDR 200 (operation S310).

Then, the DVDR 200 obtains a physical address (operation S315). The physical address has a close connection with an input port of a video apparatus connected to the DVDR 200. For example, the DVDR 200 obtains a physical address (1, 0, 0, 0) if it is connected to a first input port of the sink device, TV 100. The physical address changes if the DVDR 200 is disconnected from the TV 100 and is connected to another input port (e.g. a second input port of the TV 100 or input port of another video apparatus).

The TV controller 130 generates a physical address request message “Give Physical Address” to request a physical address and transmits it to the DVDR 200 (operation S320), and the DVDR controller 230 generates a physical address reply message “Report Physical Address” containing the obtained physical address and transmits it to the TV 100 (operation S325).

The DVDR 200, which is connected to the TV 100, performs a ping with another video apparatus connected to the TV 100 in order to be allocated a logical address of the DVDR 200 (operation S330).

Then, the DVDR 200 is allocated a logical address (operation S335). The logical address has been already defined in the CEC standard. The logical address changes every time that the ping is performed. However, if a particular external apparatus is allocated a particular logical address, other apparatuses cannot be allocated with the same logical address. Accordingly, the external apparatuses are allocated with their respective unique logical addresses. The external apparatus may have a plurality of logical addresses according to its functions. For example, the DVDR 200 is a video apparatus that has both a replay function and an audio function and thus has two logical addresses for the replay function and the audio function, respectively. Therefore, the DVDR 200 performs the replay function and the audio function simultaneously or individually.

The TV controller 130 generates a logical address request message “Give Logical Address” to request a logical address and transmits it to the DVDR 200 (operation S340), and the DVDR controller 230 generates a logical address reply message “Report Logical Address” containing the allocated logical address and transmits it to the TV 200 (operation S345). As such, data is communicable between the TV 100 and the DVDR 200.

The TV controller 130 determines whether a service list display command is received (operation S350). More specifically, if a user wishes to check services provided by the video system, the user can select a service list display menu from menus of the TV 100. Then, the TV 100 determines that the service list display command is received.

If the service list display command is received (operation S350-Y), the TV controller 130 generates a service information request message “Give Service Information” and transmits it to the external apparatuses connected to the TV 100 (operation S355). Accordingly, the DVDR controller 230 receives the service information request message through the DVDR HDMI interface 220.

The service information request message is to request information about the services provided by the video apparatuses.

The service information request message is transmitted to one of the external apparatuses connected to the TV 100 that has a destination address contained in the service information request message. In this exemplary embodiment, the destination address is the logical address of the DVDR 200. However, since the service information request message is not limited to the external apparatus having a particular address, the TV controller 130 transmits the generated service information request message to all of the external apparatuses connected to the TV 100.

The structure of the service information request message will be described in detail below. For the convenience of explanation, in this exemplary embodiment, the service information request message is transmitted to the DVDR 200 only. However, this should not be considered as limiting.

In response to the service information request message, the DVDR controller 230 generates a service information reply message “Report_Service_Information ([Service_ID], [Service^{—}Name])”, which contains service information provided by the DVDR 200, i.e., a service ID and a service name (operation S360), and the DVDR HDMI interface 220 transmits the generated service information reply message to the TV 100 (operation S365). In response to the service information request, the DVDR controller 230 transmits the service information reply message to the TV 100 through the DVDR HDMI interface 220. Accordingly, the TV controller 130 receives the service information reply message through the TV HDMI interface 120.

Through the service information reply message, the DVDR 200 which has received the service information request message provides information about services provided by itself to the TV 100 which transmitted the service information request message.

The TV 100 generates a list of services based on the service information reply message transmitted from the external apparatuses, and displays the generated list of services (operation S370). In generating a list of services, the TV controller 130 may use only service names from the service information reply message or in addition to the service names, use icons for the external apparatuses providing the service names.

The TV controller 130 determines whether a command to execute a service corresponding to a particular service item from the displayed list of services is input (operation S375). Herein, the service item means a service name or an icon for an external apparatus.

If the particular service item execution command is input (operation S375-Y), the TV controller 130 generates and transmits a service execution request message “Execute Service ([Service ID])” to the external apparatus providing the particular service (operation S380). In response to this, the external apparatus executes the particular service and provides it to the video apparatus, i.e., the TV 100.

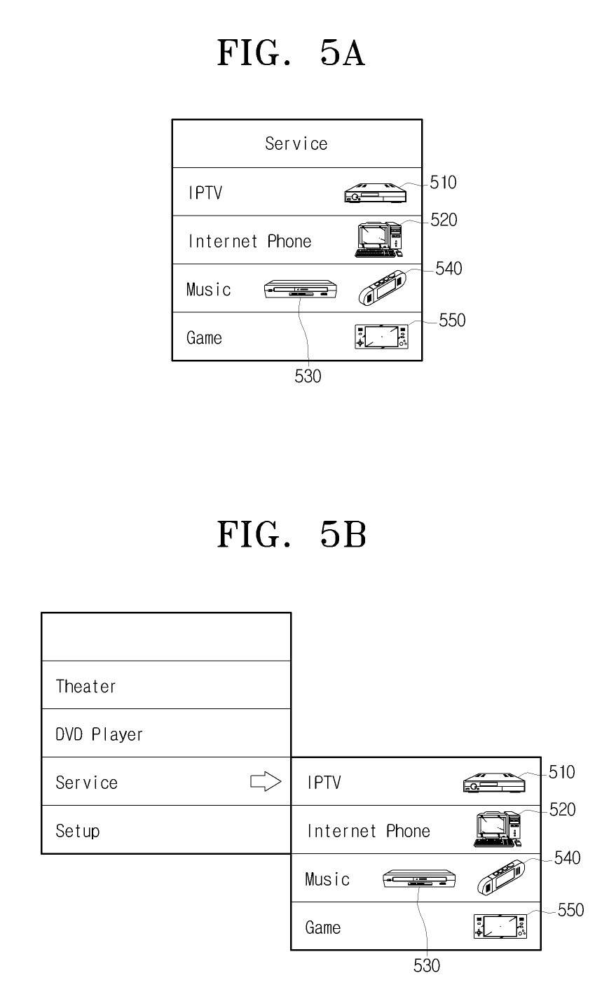

FIGS. 4A to 4E are views illustrating a message structure in relation to service information according to an exemplary embodiment of the present invention.

FIG. 4A is a view illustrating a service information request message structure according to an exemplary embodiment of the present invention. As shown in FIG. 4A, the service information request message comprises a start block representing a message start, a header block representing logical addresses of a source and of a destination, and a data block containing data for requesting service information. The data block may be divided into an opcode section and an operand section, and the data for requesting service information may be included in the opcode section.

FIG. 4B is a view illustrating a service information reply message structure according to an exemplary embodiment of the present invention. Like the service information request message, the service information reply message comprises a start block, a header block, and a data block. However, the data block comprises a service ID of the service provided by the external apparatus and a service name of the service provided by the external apparatus, in addition to data for replying to the request message.

FIG. 4C illustrates a service execution request message structure according to an exemplary embodiment of the present invention. Like the service information reply message, the service execution request message comprises a start block, a header block, and a data block. However, the service execution request message comprises in the data block data for requesting service execution and a service ID. A service name may or may not be contained in the service execution request message. This is because the external apparatus can sufficiently perceive the message to execute a particular service with the service ID only.

If there is a plurality of services provided by an external apparatus, the external apparatus may generate and transmit a plurality of service information reply messages for its respective services. Also, as shown in FIGS. 4D and 4E, if there is a plurality of services, one service information reply message may comprise in a data block a plurality of service IDs and a plurality of service names corresponding to the service IDs.

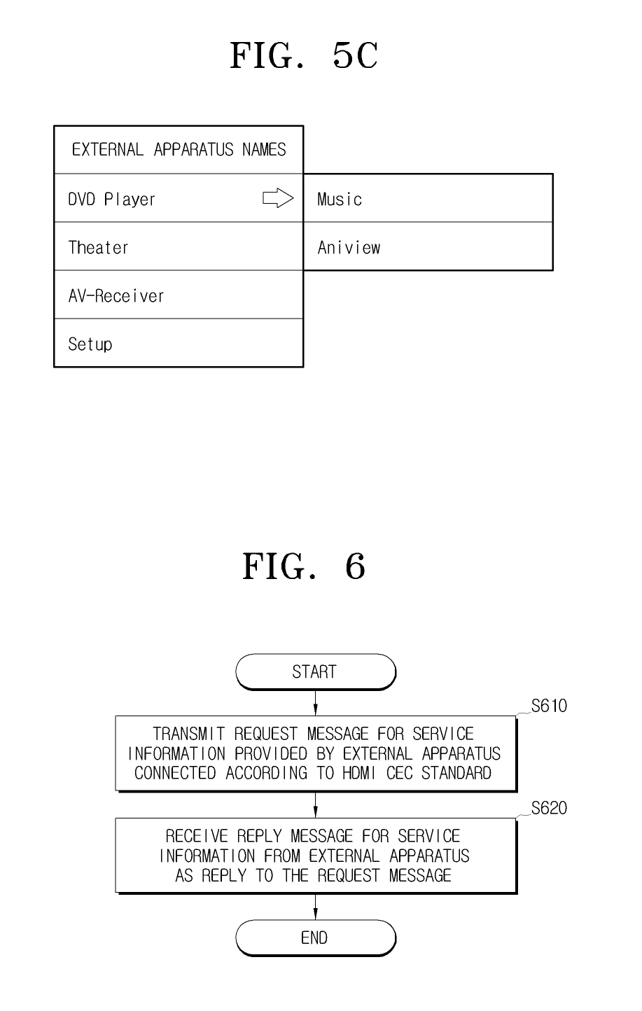

FIGS. 5A to 5B are views illustrating a list of services according to an exemplary embodiment of the present invention. As shown in FIG. 5A, a list of services is displayed by service names. Also, for the user's convenience, the TV controller 130 controls such that the service names are displayed along with icons representing external apparatus providing the services. For example, the service ‘IPTV’ is displayed along with a set-top box icon 510 positioned on the right side since this service is provided by a set-top box. The service “INTERNET PHONE” is displayed along with a computer icon 520 since this service is provided by a computer. The service ‘MUSIC’ is displayed along with icons 530 and 540 representing a DVDR and an MP3 player respectively, since this service is provided by both the DVDR and the MP3 player. Therefore, a user selects any one of the DVDR and the MP3 player icons to enjoy the service ‘MUSIC’.

FIG. 5B is a view illustrating a list of services which is included in a list of external apparatuses as one item. If a user selects “service” from the list of external apparatuses, a list of services provided by the video system, that is, information about the services provided by the external apparatuses connected to the video apparatus is displayed. Also, as shown in FIG. 5C, service information may be displayed for each external apparatus name in the list of external apparatuses.

Although the video system to which an exemplary embodiment of the present invention is applicable is established by connecting the TV 100 and the DVDR 200, the technical idea of the present invention can be applied to a video system established by other video apparatuses. The video apparatuses for the video system include a set-top box (STB), a DVD player (DVDP), a digital video recorder (DVR), a personal video recorder (PVR), a hard disk drive (HDD) player, a Blu-ray disk (BD) player, a BD recorder, a video cassette recorder (VCR), a home theater system, a personal multimedia player (PMP), a digital camera, and a digital camcorder.

Although in this exemplary embodiment the video apparatuses for the video system are defined as being connected to each other according to the HDMI CEC standard, this is merely an example for the convenience of explanation. Accordingly, the present invention can be applied to any scheme that enables video signals and messages to be transceived between the video apparatuses.

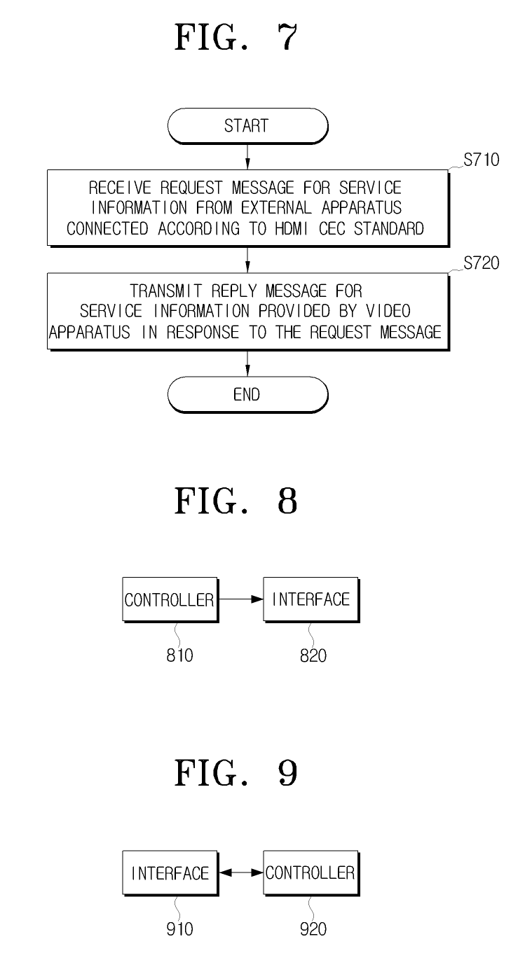

Hereinafter, another exemplary embodiment of the present invention will be described with reference to FIGS. 6 to 9. According to a method for providing service information according to another exemplary embodiment of the present invention, a video apparatus transmits a request message for service information provided by an external apparatus connected thereto according to the HDMI CEC standard (operation S610). The video apparatus receives a reply message for the service information from the external apparatus as a reply to the request message (operation S620).

According to a method for providing service information according to still another exemplary embodiment of the present invention, a video apparatus receives a request message for service information from an external apparatus connected thereto according to the HDMI CEC standard (operation S710), and in response to the request message, transmits a reply message for the service information provided by the video apparatus to the external apparatus (operation S720).

As shown in FIG. 8, according to still another exemplary embodiment of the present invention, a video apparatus providing service information comprises a controller 810 which generates a request message for service information provided by an external apparatus connected thereto according to the HDMI CEC standard, and an interface 820 which transmits the request message.

Also, as shown in FIG. 9, according to still another exemplary embodiment of the present invention, a video apparatus providing service information comprises an interface 910 which receives a request message for service information from an external apparatus connected thereto according to the HDMI CEC standard, and a controller 920 which generates a reply message for the service information provided by the video apparatus in response to the request message, and transmits the reply message to the external apparatus through the interface 910.

Accordingly, the video apparatus can obtain service information provided by the external video apparatus connected thereto.

As described above, according to exemplary embodiments of the present invention, the video apparatus obtains service information provided by the external apparatus connected thereto, and provides a user with a list of services based on the obtained service information, thereby providing a convenience to a user in using the video apparatus.

Also, the video apparatus generates service information provided by the video apparatus and provides the generated service information to the external apparatus connected thereto, thereby providing a convenience to a user.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A method for providing service information, the method comprising:
transmitting a request message to an external apparatus, which is connected according to the High Definition Multimedia Interface Consumer Electronics Control standard, the request message requesting service information provided by the external apparatus; and
receiving a reply message including the service information from the external apparatus as a response to the request message.

2. The method as claimed in claim 1, wherein the request message comprises data for requesting the service information.

3. The method as claimed in claim 1, wherein the reply message comprises at least one of data for replying to the request message, a service identifier provided by the external apparatus, and a service name provided by the external apparatus.

4. The method as claimed in claim 1, further comprising transmitting a service execution request message to the external apparatus to request an execution of a particular service contained in the reply message.

5. The method as claimed in claim 4, wherein the service execution request message comprises at least one of data for requesting the service execution and a service identifier of the particular service.

6. The method as claimed in claim 1, further comprising:
generating a list of services based on the reply message; and
displaying the list of services.

7. The method as claimed in claim 6, wherein the list of services comprises at least one of a service name provided by the external apparatus and an icon of the external apparatus.

8. A method for providing service information of a video apparatus, the method comprising:
receiving a request message from an external apparatus connected to the video apparatus according to the High Definition Multimedia Interface Consumer Electronics Control (HDMI CEC) standard, the request message requesting service information; and
in response to the request message, transmitting a reply message including the service information provided by the video apparatus to the external apparatus.

9. The method as claimed in claim 8, wherein the request message comprises data for requesting the service information.

10. The method as claimed in claim 8, wherein the reply message comprises at least one of data for replying to the request message, a service identifier provided by the video apparatus, and a service name provided by the video apparatus.

11. The method as claimed in claim 8, further comprising receiving a service execution request message from the external apparatus for requesting an execution of a particular service contained in the reply message.

12. The method as claimed in claim 11, wherein the service execution request message comprises at least one of data for requesting the service execution and a service identifier of the particular service.

13. A video apparatus comprising:
a controller which generates a request message requesting service information provided by an external apparatus connected to the video apparatus according to the High Definition Multimedia Interface Consumer Electronics Control standard; and
an interface which transmits the request message to the external apparatus.

14. The video apparatus as claimed in claim 13, wherein the request message comprises data for requesting the service information.

15. The video apparatus as claimed in claim 14, wherein the interface receives a reply message from the external apparatus as a response to the request message.

16. The video apparatus as claimed in claim 15, wherein the reply message comprises at least one of data for replying to the request message, a service identifier provided by the external apparatus, and a service name provided by the external apparatus.

17. The video apparatus as claimed in claim 15, wherein the controller generates a service execution request message to request an execution of a particular service contained in the reply message, and the interface transmits the service execution request message to the external apparatus.

18. The video apparatus as claimed in claim 17, wherein the service execution request message comprises at least one of data for requesting the service execution and a service identifier of the particular service.

19. A video apparatus for providing service information, the apparatus comprising:
an interface which receives a request message from an external apparatus connected to the video apparatus according to the High Definition Multimedia Interface Consumer Electronics Control standard, the request message requesting service information; and
a controller which, in response to the request message, generates a reply message including the service information provided by the video apparatus, and transmits the reply message to the external apparatus through the interface.

20. The video apparatus as claimed in claim 19, wherein the reply message comprises at least one of data for replying to the request message, a service identifier provided by the video apparatus, and a service name provided by the video apparatus.
